(19) United States
(12) Patent Application Publication
(10) Pub. No.: US 2007/0165651 A1
(43) Pub. Date: Jul. 19, 2007

(54) Broad band transmission path modem, radio terminal device, program, and recording medium

(76) Inventors: Kiyoshi Sukegawa, Kawasaki (JP); Yukio Furukawa, Kawasaki (JP); Kazuhiro Yoshida, Kawasaki (JP); Tetsuya Tsuboi, Kawasaki (JP); Naoki Katsuki, Kawasaki (JP); Kazuharu Kuriyama, Kawasaki (JP)

Correspondence Address: Stanley R Moore;Jenkens and Gilchrist, 1445 Ross Avenue, Suite 3200, Dallas, TX, 75202-2799, US

(21) Appl. No.: 10/586,981

(22) PCT Filed: Jan. 21, 2004
(86) PCT No.: PCT/JP04/00471

§ 371 Date: Jul. 20, 2006

(51) Int. Cl. H04L 12/56; H04L 12/54

(52) U.S. Cl. 370/401; 370/428

(57) ABSTRACT

The present invention relates to a broadband transmission path modem, a radio terminal device, a program, and a storage medium. An object of the present invention is to provide a radio terminal device with various communication services including access to the Internet etc. via a broadband transmission path at a low cost without remarkably impairing the effects of cost-cutting, downsizing, lightening, and power economization. To this end, a broadband transmission path modem according to the present invention interfaces functions, defined in advance as a specification of a radio access link, of an entity realizing a communication protocol applied to the broadband transmission path and an entity realizing the radio access link, and converts transmission information delivered to realize an added function not defined in the specification.

### TECHNICAL FIELD

The present invention relates to a broadband transmission path modem which terminates a broadband transmission path such as a digital subscriber line and which interfaces for a desired terminal to access a store-and-forward switching network or a message switching network via the broadband transmission path. It also relates to a radio terminal device which accesses the broadband transmission path as the above-mentioned terminal via a predetermined radio access link and the broadband transmission path modem or which accesses a mobile communication network, as well as to a program to realize these devices and a storage medium that stores these programs.

### BACKAROUND ART

Recently, a terminal accommodated in a mobile communication network has improved its added value, in addition to cost-cutting and downsizing, under the competition among a plurality of carriers that provide mobile communication services and among many manufacturers that manufacture terminals, and has found its use in various data transmission services such as access to the Internet, transmission and reception of e-mails, and the like, in addition to telephony communication services.

Among such terminals, particularly for a compact terminal such as a mobile terminal, it is becoming possible to exchange desired information at high speed with a personal computer and other various information terminals without using a cable therebetween and without sacrificing its downsizing and reduction in power consumption by applying not only a technology to access directly a mobile communication system in which the mobile terminal is accommodated (hereinafter, referred to simply as a first radio technology) but also a highly advanced wireless LAN and digital radio transmission technology (hereinafter, referred to simply as a second radio technology).

Further, according to a mobile terminal to which, for example, Bluetooth has been applied as the above-mentioned digital radio transmission technology, it is possible for a subscriber to make a telephone call at a position away from the mobile terminal because the mobile terminal works with a separate handset without being connected by a cable.

Furthermore, to such a mobile terminal, VoIP (Voice over Internet Protocol) which transmits phonetic speech signals as a sequence of IP packets via a LAN or the Internet is applied and for example, it is configured as follows.
Adapted to the above-described first and second radio technologies and desired one of the speech service by VoIP communication and the speech service via original mobile communication system such as PDC, WCDMA, and other system is selected adequately by an operator.
Provision of the VoIP service is realized by being equipped with a function to terminate a communication layer into which a SIP (Session Initiation Protocol) is incorporated, along with a radio interface conforming to IEEE802.3 11b.

Note that, in a mobile terminal equipped with the function to terminate the above-mentioned communication layer, along with the radio interface conforming to IEEE802.3 11b, a sequence of packets indicating speech signal (hereinafter, referred to as VoIP packets) is transmitted to a broad band router etc. via the radio interface. The broad band router realizes the transmission of the speech signals to the opposite party connected via the Internet by delivering the individual VoIP packets to the Internet side without processing these VoIP packets in a singular manner.

In such a conventional example, it is necessary to incorporate firmware that terminates the above-described communication layer in the mobile terminal, therefore, when the function or specification relating to the SIP is changed, the firmware installed in any mobile terminal needs to be updated.

However, such update of firmware is realized by downloading a new module etc. to the relevant mobile terminals.

Therefore, the function and software to be equipped by the mobile terminal have become more sophisticated and the possibility has been high that the operability of the individual mobile terminals becomes complex in vain.

Further, the second radio technology conforming to IEEE802.3 11a, b, and g is difficult to apply to a mobile terminal actually because the radio chip installed to realize such a radio technology has, in general, a large physical size and large power consumption and therefore downsizing is impeded. Further, such a mobile terminal is difficult to realize actually because its continuous operable time becomes reduced considerably unless the capacity of a mountable battery is increased and the cost including the running cost of the battery is reduced.

Note that, as prior arts relating to the present invention, there are ADSL (Asymmetric Digital Subscriber Line) modem disclosed in the patent documents 1 and 2, which will be described later, and Dual Terminal disclosed in the non-patent document 1.

[Patent document 1]

Japanese Patent Application Laid-open No. 2003-196190 (Abstract)

[Patent document 2]

Japanese Patent Application Laid-open No. 2003-289343 (Abstract)

[Non-patent document 1]

http://www.itmedia.co.jp/mobile/0312/02/n_dual.html

### DISCLOSURE OF THE INVENTION

An object of the present invention is to provide a broadband transmission path modem, a radio terminal device, programs, and a storage medium to realize at a low cost a radio terminal device with various communication services including access to the Internet etc. via a broadband transmission path, without remarkably impairing the effects of cost-cutting, downsizing, lightening, and power economization thereof.

Further, another object of the present invention is to effectively utilize not only surplus transmission capacity of a radio access link but also surplus throughput of a broadband transmission path modem and a terminal according to the present invention, as well as to heighten the added value.

Moreover, another object of the present invention is to provide various communication services in various manners.

Furthermore, another object of the present invention is to accommodate, remove, and relocate a radio terminal device easily and reliably.

Still another object of the present invention is to improve quality of service as well as a call completion ratio.

The above-described objects are attained by a broadband transmission path modem which interfaces functions of an entity in a communication layer in which a broadband transmission path is terminated and of an entity realizing a radio access link, and converts transmission information delivered to realize an added function. The functions are defined in advance as a specification of a radio access link, and the added function is a function not defined in the specification.

Such a broadband transmission path modem can provide the above-described added function to a terminal accommodated via the radio access link even when the function is a communication service that is not provided in the specification of the radio access link.

Further, the above-described objects are attained by a radio terminal device that sets up one call which occurs in a local station and whose communication channel is formed via a radio access link, and sets up another call whose communication channel is formed via a mobile communication network or a radio access link, and that maintains, when both of the calls persist as completed calls, a speech relating to one of the completed calls specified by an operator, and holds the communication channel of the other completed call.

According to such a radio terminal device, the communication channels of a plurality of completed calls that occur and persist in the local station can be selected by an operator of the radio terminal device and be reserved for a speech that can be resumed later.

Still further, the above-described objects are attained by a radio terminal device that sets up one call which occurs in a local station and whose communication channel is formed via a radio access link, and sets up another call whose communication channel is formed via a mobile communication network or a radio access link, and that delivers to the radio access link, when detecting a state that the radio access link other than the mobile communication network is accessible, a number assigned in advance to the local station and conforming to the numbering plan of a network accessible via the radio access link.

Such a radio terminal device can automatically send, to the broadband transmission path modem connected via a radio access link, a time for the local station to be accommodated in a store-and-forward switching network or a message switching network connected via the broadband transmission path as well as information necessary for the accommodation.

Further, the above-described objects are attained by a radio terminal device that registers therein in advance a number given to a terminal to be a transfer destination of a terminating call arriving at the local station, sets up one call which occurs in the local station and whose communication channel is formed via a radio access link, and set up another call whose communication channel is formed via a mobile communication network or a radio access link, and delivers the registered number to the radio access link when detecting the above-described state.

According to such a radio terminal device, even when a terminating call that occurs in the radio terminal device cannot arrive at a terminal for some reason, it can surely arrive at another terminal given a number registered in advance, with the aid of the broadband transmission path modem connected via the radio access link.

Further, the above-described objects are attained by a radio terminal device that registers therein in advance a plurality of numbers given to individual opposite parties to be a terminating party of an originating call that occurs in the local station, sets up one call which occurs in the local station and whose communication channel is formed via a radio access link and sets up another call whose communication channel is formed via a mobile communication network or a radio access link, and delivers all of the registered numbers to the radio access link when detecting the above-described state.

According to such a radio terminal device, even when an originating call that occurs in the radio terminal device cannot arrive at a desired terminating party for some reason, it can surely arrive at another terminal given the registered number in advance, with the aid of the broadband transmission path modem connected via the radio access link.

Further, the above-described objects are attained by a radio terminal device that registers therein in advance a plurality of numbers given to individual opposite parties to be a terminating party of an originating call that occurs in the local station, sets up one call which occurs in the local station and whose communication channel is formed via a radio access link and sets up another call whose communication channel is formed via a mobile communication network or a radio access link, and that re-originates, when it is determined that one of the calls as an originating call is incomplete, a call by using another number thus registered in advance and given to the opposite party to be the terminating party of the originating call.

In such a radio terminal device, even when an originating call that occurs in the radio terminal cannot arrive at a desired terminating party for some reason, it can surely arrive at another terminal given the number registered in the above-mentioned number storage unit, without the need to add a specific function to the broadband transmission path modem connected via the radio access link.

The summary of the present invention is as follow.

In a first broadband transmission path modem according to the present invention, a first interfacing section terminates a broadband transmission path through which speech signals are transmitted as a sequence of packets in compliance with a predetermined communication protocol. A second interfacing section forms a radio access link used for accommodation of a terminal accessible to a broadband transmission path. A controller interfaces functions, defined in advance as a specification of a radio access link, of an entity realizing a communication protocol and an entity realizing the radio access link, and converts transmission information delivered to realize an added function not defined in the specification.

In other words, a terminal accommodated via a radio access link can be provided with the above-described added function, even when the added function is a communication service that is not provided in the specification of the radio access link.

Therefore, it is possible to effectively utilize the surplus transmission capacity of the radio access link and the surplus throughput of the terminal and the broadband transmission path modem according to the present invention, improving the added value.

In a second broadband transmission path modem according to the present invention, a controller assigns a single channel on a radio access link to a call that occurs first in each terminal accessible to the broadband transmission path, and multiplex-transmits information about the first call and a call that occurs subsequent to the first call by using the single channel.

In other words, even in the case where channels on the above-described radio access link cannot be assigned to each call according to the specification of the radio access link, it is possible to set up in parallel a plurality of calls that occur and persist in the same terminal.

Therefore, being free from the limitation of the specification of the above-mentioned radio access link, it is possible to effectively utilize the surplus transmission capacity of the radio access link and improve the added value.

In a third broadband transmission path modem according to the present invention, an added function is a function to hold a communication channel assigned to a completed call and formed in the broadband transmission path or both the radio access link and the broadband transmission path. The completed call is specified by a terminal accommodated via the radio access link from a plurality of completed calls that occur and persist in the terminal.

In other words, the communication channels of a plurality of completed calls that occur and persist in the local station can be selected by an operator of the radio terminal device and be reserved for a speech that can be resumed later.

Therefore, it is possible to provide a variety of communication services in various manners compared to a case where selection of the communication channel to be held is limited by the specification of the above-described radio access link.

In a fourth broadband transmission path modem according to the present invention, an added function is a function to deliver transmission information between a communication channel assigned to a single completed call specified by a terminal and a single channel assigned to the terminal on the radio access link. The communication channel is one of communication channels which are formed in the broadband transmission path and individually assigned to a plurality of completed calls that occur and persist in the terminal accommodated via said radio access link.

In other words, a terminal accommodated via a radio access link is provided with a call waiting service under the initiative of a broadband transmission path modem according to the present invention, without being limited by the specification of the radio access link.

Accordingly, this improves the availability of the terminal without interposition of the store-and-forward switching network or the message switching network connected via the above-described broadband transmission path.

In a fifth broadband transmission path modem according to the present invention, an added function is a function to perform a number translation of an originating call that occurs in a terminal accommodated via the radio access link or a line transmission path, and to cause, according to a result of the number translation, the originating call to arrive at another terminal accommodated via the radio access link or the line transmission path.

In other words, a broadband transmission path modem according to the present invention can function as a private branch exchange for a plurality of terminals accommodated via the radio access link without interposition of the store-and-forward switching network or message switching network connected via the above-described broadband transmission path.

Accordingly, this improves the availability of the terminals without an increase in the load of the above-described store-and-forward switching network or message switching network.

In a sixth broadband transmission path modem according to the present invention, an added function is a function to cause, when it is identified that an originating call occurring in a terminal is to be an incomplete call, the originating call to arrive at a terminating party indicated by an alternative number given by the terminal which is accommodated via the radio access link or a line transmission path and to be routed for the outgoing route via the broadband transmission path.

In other words, a terminal accommodated in a broadband transmission path modem according to the present invention is provided with a busy transfer service under the initiative of the broadband transmission path modem.

Therefore, it is possible to improve the availability of the terminal without an increase in the load of the store-and-forward switching network or message switching network connected via the above-described broadband transmission path.

In a seventh broadband transmission path modem according to the present invention, an added function is a function to set up calls that occur and persist in individual terminals accommodated via the radio access link and with which making a call is possible via the broadband transmission path, as well as to assign a communication channel to the calls via one or both of the radio access link and the broadband transmission path.

In other words, a broadband transmission path modem according to the present invention functions as an exchange that parallelly sets up calls that occur in a terminal accommodated via a radio access link, within the transmission capacity of the radio access link. This allows improvement of the availability of the terminal at a low cost.

In an eighth broadband transmission path modem according to the present invention, an added function is a function to convert, when a terminal accommodated via the radio access link notifies a number, between the number and the IP address of the terminal in the process of call setup for the terminal, or notifies a server involving with the conversion of the number and the IP address.

In other words, the terminal accommodated via the radio access link is accommodated automatically into the store-and-forward switching network or message switching network connected via the above-described broadband transmission path, as a valid terminal at which call origination and call termination are both possible.

Accordingly, the above-described terminal is accommodated, removed and relocated easily and reliably.

In a ninth broadband transmission path modem according to the present invention, an added function is a function to judge whether or not a terminating call is able to arrive at a terminal accommodated via the radio access link or a line transmission path, and a function to transfer the terminating call to another terminal accommodated via the radio access link or the line transmission path when a result of the judgment is negative.

In other words, even when a terminating call occurring in a terminal accommodated in a broadband transmission path modem according to the present invention cannot arrive at the terminal for some reason, it can surely arrive at another terminal.

Therefore, it is possible to improve the quality of service provided to the above-described terminal in addition to the call completion ratio of the terminating calls.

In a tenth broadband transmission path modem according to the present invention, an added function is a function to judge whether or not an originating call from a terminal accommodated via the radio access link or a line transmission path can arrive at a terminating party, and to transfer the originating call to another terminating party specified by the terminal when a result of the judgment is negative.

In other words, even when an originating call that occurs in a terminal accommodated in a broadband transmission path modem according to the present invention cannot arrive at a desired terminating party for some reason, it can surely arrive at another terminating party as a substitute.

Therefore, it is possible to improve the quality of service provided to the above-described terminal in addition to the call completion ratio.

In an eleventh broadband transmission path modem according to the present invention, an added function is a function to page, when an incoming call occurs via the broadband transmission path and is to arrive at any of terminals accommodated via the radio access link or a line transmission path, a plurality of terminals accommodated via the radio access link and the line transmission path as candidates for the terminating party of the incoming call.

In other words, the above-described incoming call globally arrives at a plurality of terminals accommodated in the broadband transmission path modem according to the present invention. This can improve the quality of service provided to the above-described terminal in addition to the call completion ratio.

In a twelfth broadband transmission path modem according to the present invention, a third interfacing section interfaces a subscriber line accessible via a circuit line switching network with an access point which is connected to a store-and-forward switching network or a message switching network accessible via the broadband transmission path. The added function is a function to authenticate a terminal accommodated via the radio access link and to access, upon completion of the authentication, the store-and-forward switching network or message switching network based on the predetermined communication protocol via the access point.

In other words, the terminal is allowed to access the above-described store-and-forward switching network or message switching network via the above-described access point only when the above-described authentication is completed for the terminal.

Therefore, even when there is no continuous connection via a broadband transmission path, a terminal accommodated via a radio access link is provided with a telephone service via the network and a service that enables the terminal to access the above-described store-and-forward switching network or message switching network.

In a thirteenth broadband transmission path modem according to the present invention, an added function is a function to multicast, to all of communication channels of a plurality of completed calls that occur and persist in terminals accommodated via the radio access link, transmission information delivered via the other communication channels.

In other words, the terminal accommodated via the radio access link can be used for making a conference call with opposite parties of the plurality of completed calls that occur in the terminal.

Therefore, effectively utilizing the surplus transmission capacity of the radio access link makes it possible to improve the availability of the above-mentioned terminal.

In a first radio terminal device according to the present invention, a first interfacing section interfaces with a mobile communication network. A second interfacing section interfaces with a radio access link other than the mobile communication network. A controller sets up one call that occurs in the local station and whose communication channel is formed via the radio access link and sets up another call whose communication channel is formed via the mobile communication network or the radio access link, and maintains, when both of the calls persist as completed calls, a speech relating to one of the completed calls specified by an operator, and holds the communication channel of the other completed call.

In other words, the communication channels of the plurality of completed calls that occur and persist in the radio terminal device according to the present invention are selected by an operator of the radio terminal device and are reserved for a speech that can be resumed later.

Therefore, a variety of communication services can be provided in various manners compared to a case where selection of the communication channel to be held is limited by the specification of the above-described radio access link.

In a second radio terminal device according to the present invention, a first interfacing section interfaces with a mobile communication network. A second interfacing section is used for accessing a radio access link other than the mobile communication network, when detecting a state that the access is possible. A controller sets up one call that occurs in a local station and whose communication channel is formed via the radio access link and sets up another call whose communication channel is formed via the mobile communication network or the radio access link. When detecting the state, the second interfacing section delivers to the radio access link a number assigned in advance to the local station and conforming to a numbering plan of a network accessible via the radio access link.

In other words, the radio terminal device according to the present invention can automatically send, to the broadband transmission path modem connected via a radio access link, a time for the local station to be accommodated as a valid terminal in a store-and-forward switching network or a message switching network connected via the broadband transmission path as well as information necessary for the accommodation.

Therefore, the radio terminal device according to the present invention can be accommodated, removed, and relocated easily and reliably.

In a third radio terminal device according to the present invention, a first interfacing section interfaces with a mobile communication network. A second interfacing section is used for accessing a radio access link other than the mobile communication network, when detecting a state that the access is possible. A profile storage section has registered a number given to a terminal to be a transfer destination of a terminating call that is to arrive at a local station. A controller sets up one call that occurs in the local station and whose communication channel is formed via the radio access link and sets up another call whose communication channel is formed via the mobile communication network or the radio access link. When detecting the state, the second interfacing section delivers the number registered in the profile storage section to the radio access link.

In other words, even when a terminating call that occurs in the radio terminal device according to the present invention cannot arrive at the radio terminal device for some reason, it can surely arrive at another terminal given a number registered in the above-mentioned profile storage section, with the aid of the broadband transmission path modem connected via the radio access link. This accordingly improves the quality of service in addition to the call completion ratio.

In a fourth radio terminal device according to the present invention, a first interfacing section interfaces with a mobile communication network. A second interfacing section is used for accessing a radio access link other than the mobile communication network, when detecting a state that the access is possible. A number storage section has registered therein a plurality of numbers given to individual opposite parties to be terminating parties of an originating call from the local station. A controller sets up one call that occurs in the local station and whose communication channel is formed via the radio access link and sets up another call whose communication channel is formed via the mobile communication network or the radio access link. When detecting the state, the second interfacing section delivers all of the numbers registered in the number storage section to the radio access link.

In other words, even when an originating call that occurs in the radio terminal device according to the present invention cannot arrive at a desired terminating party for some reason, it can surely arrive at another terminal given a number registered in the above-mentioned number storage section, with the aid of the broadband transmission path modem connected via the radio access link. This improves the quality of service in addition to the call completion ratio.

In a fifth radio terminal device according to the present invention, a first interfacing section interfaces with a mobile communication network. A second interfacing section is used for accessing a radio access link other than the mobile communication network, when detecting a state that the access is possible. A number storage section has registered therein a plurality of numbers given to individual opposite parties to be terminating parties of an originating call from a local station. A controller sets up one call that occurs in the local station and whose communication channel is formed via the radio access link and sets up another call whose communication channel is formed via the mobile communication network or the radio access link, and re-originates a call, when it is determined that one of the calls as an originating call is incomplete, by using another number registered in the number storage section and given to an opposite party as a terminating party of the originating call.

In other words, even when an originating call that occurs in the radio terminal device according to the present invention cannot arrive at a desired terminating party for some reason, it can surely arrive at another terminal given a number registered in the above-mentioned number storage section, without the need to add a specific function to the broadband transmission path modem connected via the radio access link. This improves the quality of service in addition to the call completion ratio.

In a sixth radio terminal device according to the present invention, a controller causes, when an originating call occurs in the local station, the originating call to arrive at a terminating party via one of the mobile communication network and the radio access link which conforms to all of or part of a result of a number translation of the terminating party of the originating call, an instruction of an operator, and a predetermined program.

In other words, at the call origination the radio terminal device according to the present invention can directly access the above-described mobile communication network or access the store-and-forward switching network or the message switching network via the radio access link in cooperation with the broadband transmission path modem.

Therefore, the radio terminal device according to the present invention can be provided with a communication service via network according to the intention of an operator, the location of the radio terminal device, and other conditions.

In a seventh radio terminal device according to the present invention, for delivering information about setup of a call that occurs first in the local station and a call that occurs subsequent to the first call, a controller multiplex-transmits the information by using a single channel assigned to the first call and formed on the radio access link.

In other words, the radio terminal device according to the present invention can perform call setup in parallel for a plurality of calls that occur and persist in the local station even in the case where it cannot assign a channel on the above-described radio access link to each call under the specification of the radio access link.

Therefore, it is possible to effectively utilize the surplus transmission capacity of the radio access link without undergoing limitations of the specification of the above-mentioned radio access link, increasing the added value.

### BRIEF DESCRIPTION OF THE DRAWINGS

FIG. 1 is a diagram showing first to ninth embodiments of the present invention;

FIG. 2 is a diagram showing a detailed configuration of an ADSL modem;

FIG. 3 is a diagram showing a detailed configuration of a terminal;

FIG. 4 is a diagram explaining the operation in the first to ninth embodiments of the present invention;

FIG. 5 is a flow chart of the operation of the ADSL modem in the first to ninth embodiments of the present invention; and

FIG. 6 is a flow chart of the operation of the terminal in the first to ninth embodiments of the present invention.

### BEST MODES FOR CARRYING OUT THE INVENTION

Embodiments of the present invention are explained below in detail with reference to drawings.

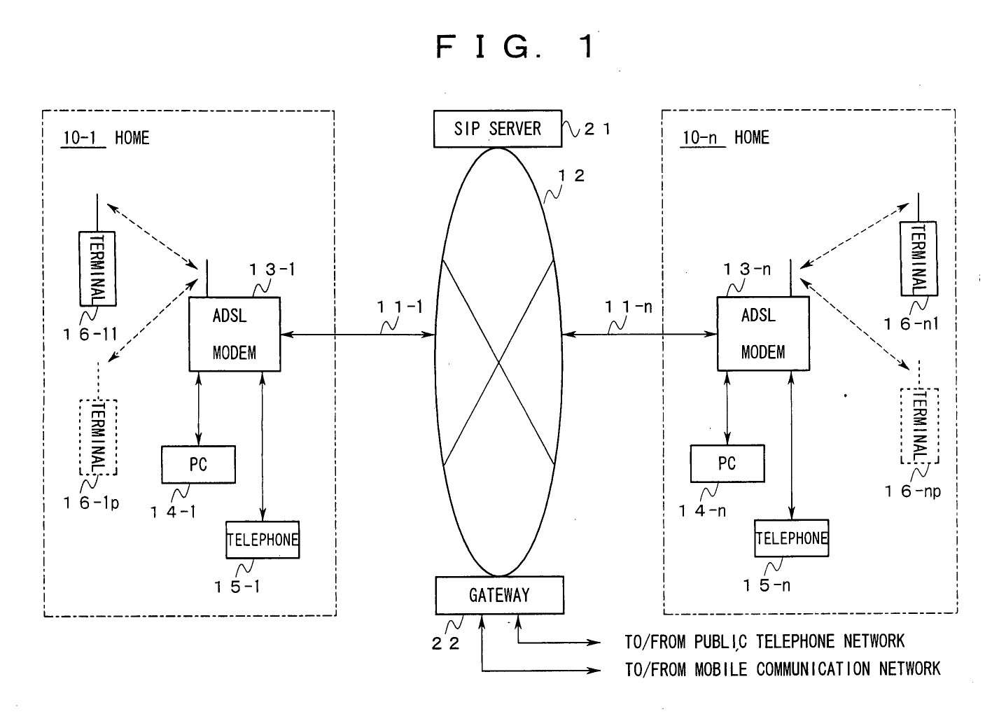

FIG. 1 is a diagram showing first to ninth embodiments of the present invention.

In the drawing, the following components are arranged in a home 10-1.
An ADSL modem 13-1 connected to the Internet (here, assumed to adapt to the above-described SIP) 12 via an ADLS 11-1
A personal computer (PC) 14-1 having a bus such as USB connected to the ADSL modem 13-1 or a predetermined communication link
A telephone 15-1 provided in the ADSL modem 13-1 and connected via an interface compatible with a two-wire subscriber line
A single or a plurality (p) of terminals (here, assumed to be a mobile terminal) 16-11 to 16-1 p provided in the ADSL modem 13-1, capable of individually accessing the ADSL modem 13-1 via a radio link conforming to Bluetooth, and also capable of adequately accessing a radio base station (not shown) of a mobile communication system to which a predetermined multiple access, channel arrangement, etc., have been applied

To the Internet 12, ADSL modems 13-2 to 13-n individually provided in homes 10-2 to 10-n the configuration of which is the same as that of the home 10-1 are connected via ADSLs 11-2 to 11-n, respectively. The configurations of the homes 10-2 to 10-n are shown in FIG. 1 only for those of the homes 10-1 and 10-n and hereinafter, they are indicated by attaching “2” to “n” to the respective symbols of the respective corresponding components as a first numerical subscript.

Further, to the Internet 12, a SIP server that mediates activation of a session relating to the above-mentioned home 10-1 (corresponding to a user agent) and other processing and a gateway 22 that interfaces between a public telephone network and a mobile communication network are connected.

Hereinafter, items common to the homes 10-1 to 10-n are described by attaching an alphabetical subscript “C” indicating that the items apply to any of the numeric numbers “1” to “n” corresponding to the homes 10-1 to 10-n to the symbol of the corresponding component.

Further, in all of the homes 10-14 to 10-n, items common to all of the terminals attached with symbol “16” are described by attaching an alphabetical subscript “c” as a second subscript following the first subscript indicated by the above-mentioned alphabetical subscript “C”.

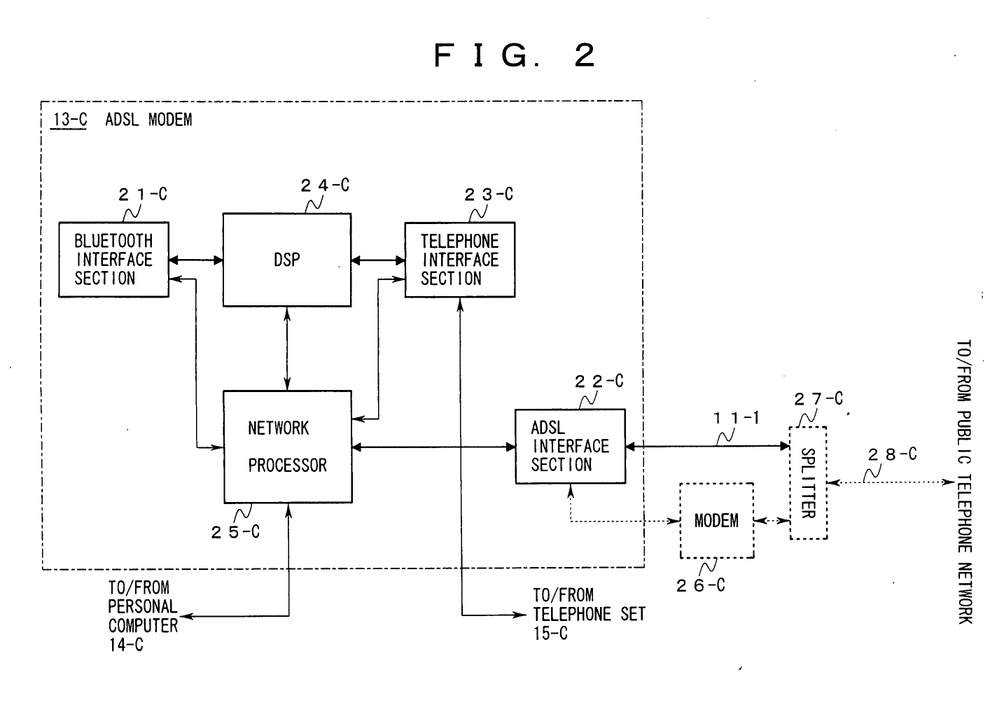

FIG. 2 is a diagram showing a detailed configuration of an ADSL modem.

In the drawing, the above-described ADSL modem 13-C is configured by the following components.
A Bluetooth interface section 21-C that forms a radio transmission path conforming to the above-described Bluetooth
An ADSL interface section 22-C that interfaces with an ADSL 11-C
A telephone interface section 23-C that interfaces with a telephone set 15-C
A digital signal processing processor (DSP) 24-C having analog ports individually connected to a modulation/demodulation terminal of the Bluetooth interface section 21-C and an input/output terminal of the telephone interface section 23-C
A network processor 25-C having a port connected to a personal computer 14-C and input/output ports connected to the corresponding terminals of the Bluetooth interface section 21-C, the ADSL interface section 22-C, the telephone interface section 23-C, and the digital signal processing processor 24C

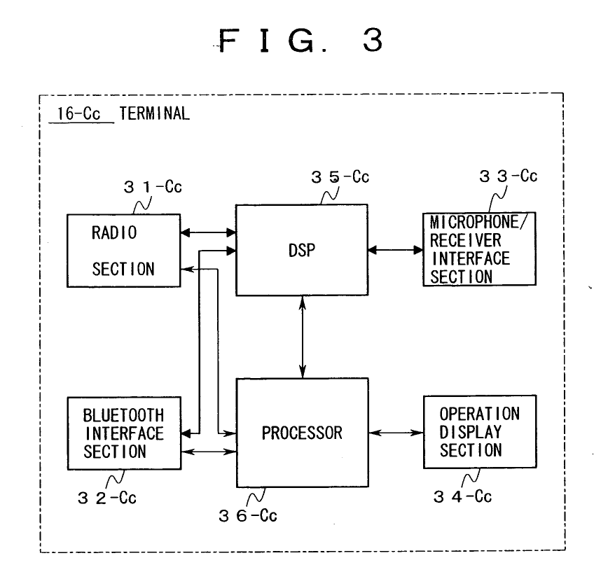

FIG. 3 is a diagram showing a detailed configuration of a terminal.

In the drawing, a terminal 16-Cc is configured by the following components.
A radio section 31-Cc that interfaces with a radio transmission path provided for access to a radio base station of the above-described mobile communication system
A Bluetooth interface section 32 Cc that forms a radio transmission path conforming to Bluetooth between the ADSL modem 13-C (the Bluetooth interface section 21-C) and itself
A microphone/receiver interface section 33-Cc that interfaces with a microphone and a receiver (not shown) provided for sending and receiving speeches by an operator of the terminal 16-Cc
An operation display section 34-Cc configured by a pushbutton and display unit provided for the man-machine interface with the operator
A digital signal processing processor (DSP) 35-Cc having analog ports individually connected to modulation/demodulation terminals of the above-mentioned radio section 31-Cc and the Bluetooth interface section 32-Cc and an input/output terminal of the microphone/receiver interface section 33Cc
A processor 36-Cc having input/output ports individually connected to control terminals of the radio section 31-Cc, the Bluetooth interface section 32-Cc, the operation display section 34-Cc, and the digital signal processing processor 35-Cc

The basic operation and related process performed by respective sections in each embodiment to be described later are explained below.

The ADSL modem 13C interconnects with the terminal 16-Cc by exchanging predetermined information with the terminal 16-Cc via a radio transmission path conforming to Bluetooth and provides a telephonic speech service to the terminal 16-Cc, in addition to a communication service that enables access to the Internet 12.

Such an cooperation is realized as an interface between a profile incorporated in advance as a specification that realizes a function conforming to Bluetooth and a predetermined communication protocol (including not only TCP and IP but also the above-described SIP) applied to the ADSL 11-C provided for access to the Internet 12.

The above-described information is delivered mutually between the processor 36-Cc and the network processor 25-C opposing each other via the above-described Bluetooth interface section 32-Cc and the Bluetooth interface section 21-C.

Therefore, the interface between the above-described profile and the predetermined communication protocol applied to the ADSL 11-C is realized in actual as a consistency of the units of the function defined in advance as the profile between the respective entities that realize the profile and the communication protocol.

Each embodiment to be described later omits description on, for example, the basic call processing of a telephonic call that occurs in the terminal 16-Cc (including processing to realize not only origination, termination response, disconnection, speech ending, etc., as well as transmission of speech signals via the ADSL 11-C and the Internet 12 by applying VoIP, a process of cooperation of respective sections realized by utilizing a function defined and incorporated in advance as the above-described profile because they are not characteristic to the present invention.

Further, in each embodiment to be described later, messages are delivered between the processor 36-Cc provided in the terminal 16-Cc and the network processor 25-C provided in the ADSL modem 13-C via the Bluetooth interface sections 32-Cc and 21-C, similar to the above-described information.

Therefore, explanation of the detailed operation of each section relating to such delivery of message is omitted below.

(Basic Operation of the Terminal 16-Cc)

The processor 36-Cc man-machine interfaces with an operator via the operation display section 34-Cc and initiatively controls the behavior of the radio section 31-Cc, the Bluetooth interface section 32-Cc, and the digital signal processing processor 35-Cc.
The radio section 31-Cc accesses a mobile communication network in which the terminal 16-Cc is accommodated originally via a nearest radio base station (not shown) under the initiative of the processor 36-Cc and realizes call setup and channel control relating to a call that occurs in the local station.
The Bluetooth interface section 32-Cc adequately forms a radio transmission path conforming to Bluetooth (hereinafter, referred to as a Bluetooth transmission path) between the ADSL modem 13-C (the Bluetooth interface section 21-C) and itself under the initiative of the processor 36-Cc and realizes transmission of transmission information via the Bluetooth transmission path.
The microphone/receiver interface section 33-Cc delivers audio frequency signals including speech signals, ringing tones, and other various tone signals between an operator and the digital signal processing processor 35-Cc via a microphone and a receiver, not shown.
The digital signal processing processor 35-Cc generates and detects the above-described tone signal (including a DTMF signal) as well as delivering speech signals between both or either of the radio section 31-Cc and the Bluetooth interface section 32-Cc and the microphone/receiver interface section 33-Cc.
   (Basic Operation of ADSL Modem 13-C)
The network processor 25-C initiatively controls the behavior of the Bluetooth interface section 21-C, the digital signal processing processor 24-C, the telephone interface section 23-C, and the ADSL interface section 22-C and interconnects with the personal computer 14-C by exchanging predetermined information via the above-described communication port.
The Bluetooth interface section 21-C adequately forms a Bluetooth transmission path between the terminal 16-Cc (the Bluetooth interface section 32-Cc) and itself under the initiative of the network processor 25-C and realizes transmission of transmission information via the Bluetooth transmission path.
The ADSL interface section 22-C accesses the Internet 12 via the ADSL 11-C under the initiative of the network processor 25-C and sets up a call relating to a telephonic call that occurs in the terminal 16-Cc and the speech signals of which should be delivered based on the above-described VoIP. (call setup is realized as predetermined session activated under the command of SIP).
The telephone interface section 23-C delivers the audio frequency signals including speech signals, ringing tones, and other various tone signals between an operator and the digital signal processing processor 24-C via the telephone 15-C under the initiative of the network processor 25-C and interfaces with the telephone 15-C based on the predetermined two-wire subscriber line signaling system (including delivery of line signals meaning origination or speech ending and the resister signals indicating a dial number).
The digital signal processing processor 24-C generates and detects the above-described tone signal (including a DTMF signal) as well as delivering speech signals between the Bluetooth interface section 21-C, the telephone interface section 23-C, and the ADSL interface section 22-C under the initiative of the network processor 25-C. Note that the speech signals transmitted and received as a sequence of IP packets via the ADSL interface section 22 and the ADSL 11-C are delivered via the network processor 25-C interposed between the ADSL interface section 22 and itself.

The first to eighth embodiments to be described later are characterized in that the steps to realize a function not defined as the above-described profile is processed by the processor 36-Cc provided in the terminal 16-Cc in cooperation with the network processor 25-C provided in the ADSL modem 13-C, and that respective sections operate in cooperation with each other under the initiative of the processor 36-Cc and the network processor 25-C.

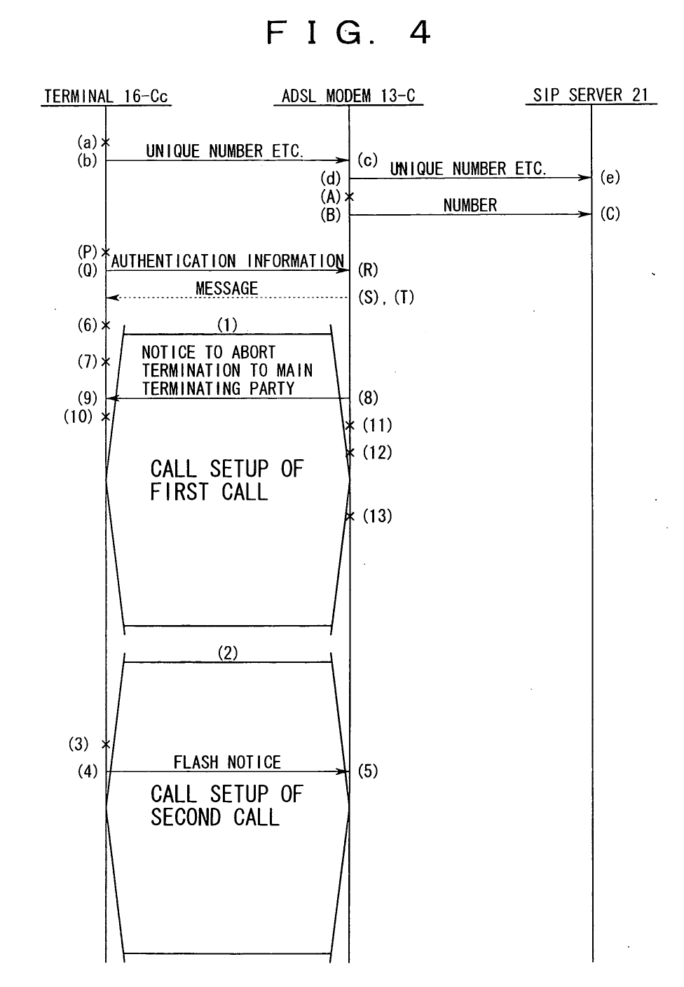

FIG. 4 is a diagram for explaining the operation in the first to ninth embodiments of the present invention.

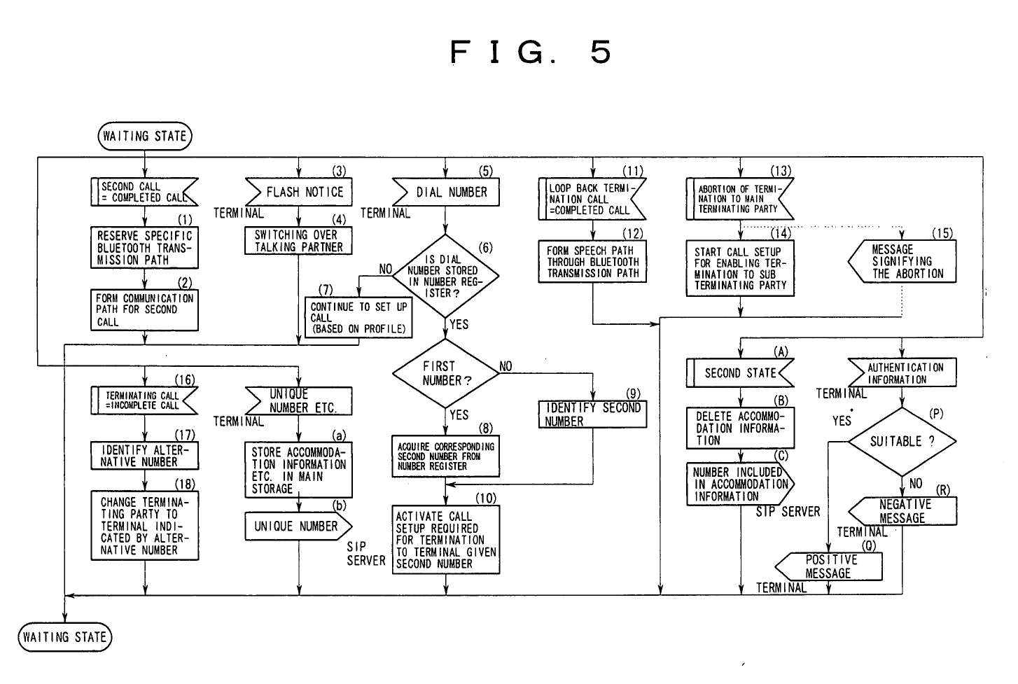

FIG. 5 is a flow chart of the operation of the ADSL modem in the first to ninth embodiments of the present invention.

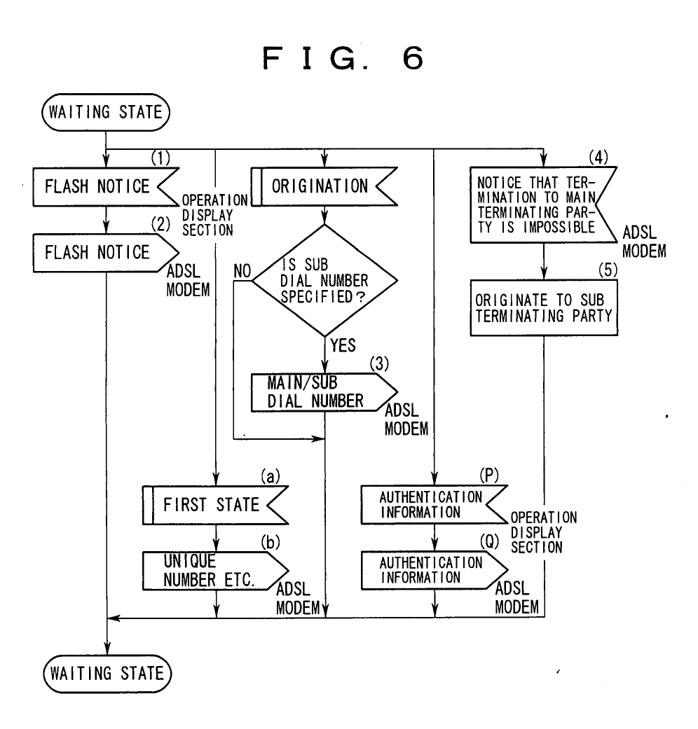

FIG. 6 is a flow chart of the operation of the terminal in the first to ninth embodiments of the present invention.

### FIRST EMBODIMENT

The operation of a first embodiment of the present invention is explained below with reference to FIG. 1 to FIG. 6.

While a first call (either an originating call or a terminating call) occurring in the terminal 16-Cc and whose opposite party is to be any one of terminals connected to the Internet 12 becomes a completed call, the terminal 16-Cc and the ADSL modem 13-C exchange the above-described information via the above-described Bluetooth transmission path (FIG. 4(1)), and the terminal 16-Cc is assigned the Bluetooth transmission path to be provided for the transmission of the speech signals of the first call (hereinafter, referred to as a specific Bluetooth transmission path).

In the process of setting up another call (hereinafter, referred to as a second call and may be either an originating call or a terminating call) that occurs in the terminal 16-Cc at which the first call persists as a completed call, the information about the call processing of the second call is delivered to and from each other by being multiplexed to the speech signals of the first call transmitted via the above-described specific Bluetooth transmission path under the initiative of the processor 36-Cc and the network processor 25-C provided in the terminal 16-Cc and the ADSL modem 13-C, respectively (FIG. 4(2)).

Hereinafter, a transmission path formed by thus multiplexing to the speech signals of the first call is referred to as a sub Bluetooth transmission path.

The processor 36-Cc and the network processor 25-C do not set up a call based on the above-described profile in a state in which the first call that has occurred precedently persists as a completed call but sets up the second call as event driven processing that is activated in accordance with the information thus multiplexed and delivered.

At the ADSL modem 13-C, the network processor 25-C performs the following processing when the second call is completed as long as the above-described first call persists as a completed call.
Sending out the speech signals (hereinafter, referred to as the first downstream speech signals) to the opposite party of the first call (hereinafter, referred to as a first opposite party) and aborting the deliver of the speech signals (hereinafter, referred to as the first upstream speech signals) given from the opposite party via the ADSL 11-C to the specific Bluetooth transmission path and at the same time, discarding the sequence of the IP packets indicating the first upstream speech signals (FIG. 5(1)).
Delivering the speech signals (hereinafter, referred to as the second downstream speech signals) delivered from the terminal 16-Cc via the specific Bluetooth transmission path to the opposite party of the second call (hereinafter, referred to as the second opposite party) via the ADSL 11-C
Delivering the speech signals (hereinafter, referred to as the second upstream signals) given from the second opposite party via the ADSL 11-C to the terminal 16-Cc via the specific Bluetooth transmission path (FIG. 5(2)).

In the terminal 16-Cc, each time detecting that an operator has performed a predetermined operation (hereinafter, referred to simply as a flash operation) via the operation display section 34-Cc (FIG. 4(3), FIG. 6(11)), the processor 36-Cc notifies a message to that effect (hereinafter, referred to as a flash notice) as transmission information multiplexed to the first or second downstream speech signals to the ADSL modem 13-C via the specific Bluetooth transmission path (FIG. 4(4), FIG. 6(2)).

In the ADSL modem 13-C, the network processor 25-C performs the following processing each time identifying the flash notice (FIG. 4(5), FIG. 5(3)).
Aborting alternately sending out the first downstream speech signals to the first opposite party and sending out of the second downstream speech signals to the second opposite party
Switching alternately between the sequence of IP packets indicating the first upstream speech signals and the sequence of IP packets to be discarded among the sequence of IP packets indicating the second upstream speech signals (FIG. 5(4)).

When one of the completed calls has become extinct, the network processor 25-C and the processor 36-Cc select only the speech signals relating to the remaining completed calls as the speech signals to be transmitted via the specific Bluetooth transmission path and the ADSL 11-C.

When the completed call that has thus become extinct is the above-described first call, the delivery of the information about speech ending of the remaining completed call (the second call) and other call processing between the ADSL modem 13-C and the terminal 16-Cc may be performed via either the sub Bluetooth transmission path or the specific Bluetooth transmission path determined based on the above-described profile.

In other words, about any of the terminals that have been accommodated under the control of the ADSL 11-C via the Bluetooth transmission path, call setup of a plurality of calls that have occurred in parallel is performed and in the period during which the calls persist as completed calls, a speech is made with a desired opposite party specified by an operator of the corresponding terminal.

As described above, according to the present embodiment, by realizing a function not supported by the existing profile as simple processing, the surplus transmission capacity of the Bluetooth transmission path and the ADSL 11-C can be utilized effectively.

Further, as already described, the terminal 16-Cc that is accommodated via the Bluetooth transmission path is provided with the call waiting service also for the speech by an IP telephone at a low cost and without a considerable increase in power consumption.

Therefore, according to the present embodiment, the availability of not only the IP telephone network but also the mobile communication network is improved synergistically and it is made possible for the terminal 16-Cc to make a speech with a desired party via the IP telephone network in which the speech fee is less than that in the mobile communication network in a state in which the terminal 16-Cc is accommodated in the ADSL modem 13-C via the above-mentioned Bluetooth transmission path.

In the present embodiment, both of the above-described first speech party and second speech party are the terminals provided with telephone services by VoIP via the Internet 12.

However, the present invention is not limited to such a configuration and even in the case where, for example, the telephone 15-C directly connected to the ADSL modem 13-C corresponds to either of the first opposite party and second opposite party, as long as the speech signals to be delivered to the terminal 16-Cc via the specific Bluetooth transmission path under the command of the network processor 25-C are properly selected by the digital signal processing processor, realization is possible similarly.

In the present embodiment, the number of calls that have occurred in parallel in the terminal 16-Cc and completed calls is “2”.

However, the number may be “3” or greater as long as the information delivered via the Bluetooth transmission path (including the sub Bluetooth transmission path) in the call processing of each call is distinct from another and the transmission capacity of the Bluetooth transmission path is sufficient, and at the same time, an increase in the load of the ADSL modem 13-C and the terminal 16-Cc can be permitted.

Further, in the present embodiment, the speech of the completed call that occurs and persists in the terminal 16-Cc is realized as the above-described call waiting.

However, the present invention is not limited to such a configuration and it may also be possible to realize a conference call by performing processing to realize interactive multicast of the speech signals between the opposite party of the completed call and the terminal 16-Cc with the digital signal processing processor in accordance with an operation performed by an operator of the terminal 16-Cc.

### SECOND EMBODIMENT

The operation of a second embodiment of the present invention is explained below with reference to FIG. 1 to FIG. 5.

The present embodiment is characterized by the following procedure of call setup performed under the initiative of the network processor 25-C provided in the ADSL modem 13-C in a state that a second call does not occur after an originating call occurs as the above-described first call.

First, the call setup of the first call is performed based on the above-described profile until a dial number is given by the terminal 16-Cc.

In the specific storage region of the main memory of the network processor 25-C, a number register in which the following first number and second number are registered in advance, is arranged, which numbers are assigned individually with respect to the terminals 16-Cl to 16-Cp accommodated under the command of the ADSL modem 13-C via the Bluetooth transmission path.
The first number (for example, “0901234-5678”) unique in the above-described mobile communication network
The second number (for example, “050-1234-5678”) unique in the VoIP network

The contents of such a number register may be any of the following information.
Information delivered from the personal computer 14-C adequately or at a time
Information notified individually from the terminals 16-Cl to 16-Cp via the Bluetooth transmission path
Information identified and acquired by the network processor 25-C provided in the ADSL modem 13-C in the process of assignment to the 16-Cl to 16-Cp by the SIP server 21 via the Internet 21, the ADSL 11-C, the ADSL modem 13-C, and the Bluetooth transmission path

The network processor 25-C performs the following processing when a dial number (may correspond to either of the above-described first number or second number) is given by the terminal 16-Cc (FIG. 4(6), FIG. 5(5)) in the process of the call setup of the above-described first call.
(1) Judging whether or not the corresponding dial number is stored in the above-described number register (FIG. 5(6))
(2) When the result of the judgment is false, continuing to set up a call following the first call (FIG. 5(7)) based on the above-described profile and omitting the following processing (3) to (7)
(3) When the result of the judgment is true, performing the following processing (4) to (7)
(4) When the relevant dial number corresponds to the above-described first number, acquiring the second number associated with the first number and stored in the number register (FIG. 5(8)) and when the dial number corresponds to the second number, identifying the second number (FIG. 5(9))
(5) Activating a call setup required for termination to a terminal (hereinafter, referred to as a loop back termination terminal) to which the second number has been thus acquired and identified among the terminals 16-Cl to 16-Cp (FIG. 5(10))
(6) When the relevant first call is completed (FIG. 4(7), FIG. 5(11)) by the completion of the termination to such a loop back termination terminal, instructing the digital signal processing processor 24-C to form a full-duplex transmission speech path between the two Bluetooth transmission paths assigned individually based on the profile to the terminal that is the originating party of the first call and the loop back termination terminal (FIG. 5(12))
(7) In the process in which the relevant completed call becomes extinct, instructing the digital signal processing processor 24-C to release the speech path

In other words, the speech path of a completed call, in which both the originating party and the terminating party are the terminals accommodated in the ADSL modem 13-C via the Bluetooth transmission path, is formed without the mobile communication network and the VoIP network being interposed under the above-described processing performed by the network processor 25-C provided in the ADSL modem 13-C.

As described above, according to the present embodiment, by effectively utilizing the transmission capacity of the Bluetooth transmission path, it is possible to realize an internal call efficiently at a low cost.

Therefore, the concentration of traffics resulting from access to the mobile communication network and VoIP network each time a call that realizes such an internal call occurs, or reduction in the call completion ratio is relaxed and at the same time, the speech quality or the service quality is kept at a high level.

In the present embodiment, both the originating party and the termination party are the terminals accommodated in the ADSL modem 13-C via the Bluetooth transmission path.

However, the present invention is not limited to such the case and even in the case where either of the above-described originating party and the termination party is the above-described telephone 15-C, as long as the processing according to the above-described processing (1) to (7) is attained, application is possible similarly.

### THIRD EMBODIMENT

The operation of a third embodiment of the present invention is explained below with reference to FIG. 1 and FIG. 2.

The present embodiment is characterized by the procedure of the following processing performed by the network processor 25-C provided in the ADSL modem 13-C.

The network processor 25-C assigns the specific Bluetooth transmission path individually based on the above-described profile to the calls (completed calls) that have occurred from the terminals, the number of which is equal to or less than the maximum number of the links that can be formed in parallel under the specification of Bluetooth among the terminals 16-Cl to 16-Cp.

The network processor 25-C manages in a centralized manner the unique identification information indicating both or either of the originating party and the terminating party and other resources assigned in the process of call setup, along with the identifier of the specific Bluetooth transmission path assigned individually for each call.

Further, under such management the network processor 25-C interfaces, for all of the calls that occur and persist, between an entity corresponding to a communication layer in which the corresponding specific Bluetooth transmission path is formed and an entity corresponding to a layer of each session activated by the above-described SIP, thereby forming and managing a communication channel for transmission and delivery of the communication signals of the calls.

Therefore, according to the present embodiment, a plurality of terminals capable of making a speech in parallel via the VoIP network under the command of the ADSL modem 13-C and the transmission capacity of the Bluetooth transmission path can be utilized at maximum by these terminals.

### FOURTH EMBODIMENT

The operation of a fourth embodiment of the present invention is explained below with reference to FIG. 1 to FIG. 3, FIG. 5, and FIG. 6.

The present embodiment is characterized by the procedure of the following processing performed by the network processor 25-C provided in the ADSL modem 13-C.

In the terminal 16-Cc, at the time of origination, a dial number indicating a desired terminating party (hereinafter, referred to as a main dial number) and a dial number indicating another terminating party that can be in place of the terminating party (hereinafter, referred to as a sub dial number) are specified via the operation display section 34-Cc.

The processor 36-Cc delivers the main dial number and the sub dial number to the ADSL modem 13-C via the Bluetooth transmission path (FIG. 6(3)). Here, it is assumed that delivery of such the dial numbers is attained based on the above-described profile.

On the other hand, in the ADSL modem 13-C, the network processor 25-C starts processing that enables termination to the terminating party indicated by the main dial number (hereinafter, referred to as the main terminating party and here, it is assumed to be a terminal accommodated in the VoIP network for simplification of explanation) by applying only the above-described main dial number in the process of call setup of an originating call that occurs from the terminal 16-Cc.

However, in the process of such processing, if termination to the main terminating party is blocked by the busy state, congestion, obstruction, or other factors, and there is no response from the terminal of the main terminating party (including a case where the subscriber does not respond for a predetermined long period of time although ringing signals are being sent out) (FIG. 5(13), the network processor 25-C performs the following processing.
(1) Aborting processing relating to termination to the main terminating party
(2) Starting call setup that enables termination to the terminating party indicated by the sub dial number (hereinafter, referred to as the sub terminating party and here, it is assumed to be a terminal accommodated in the VoIP network for simplification of explanation) by applying the above-described sub dial number in place of the main dial number (FIG. 5(14))

In other words, in the terminal 16-Cc, a speech with any of the desired terminating parties indicated by the plurality of dial numbers is realized with a high probability by a simple operation in which a plurality of dial numbers are specified.

Therefore, according to the present embodiment, the call completion ratio of originating calls that occur from the terminal accommodated via the Bluetooth transmission path is increased and the quality of services provided to the terminals can be improved at a low cost without the hardware configuration of the ADSL modem 13-C being modified fundamentally.

In the present embodiment, the sub dial number is delivered at a time to the ADSL modem 13-C along with the main dial number at the time of origination by the terminal 16-Cc of the originating party.

However, it may also be possible for the sub dial number to be notified for the first time by the terminal 16-Cc (processor 36-Cc) in response to the request issued from the network processor 25-C via the Bluetooth transmission path when, for example, the termination to the main terminating party is blocked, or when it is identified that there is no response from the main terminating party.

Further, in the present embodiment, the single sub dial number is delivered along with the main dial number to the ADSL modem 13-C.

However, the number of sub dial numbers may be two or more as long as they are identified individually by the network processor 25-C and applied to the processing that enables termination to the alternative terminating party.

### FIFTH EMBODIMENT

The operation of a fifth embodiment of the present invention is explained below with reference to FIG. 1 to FIG. 6.

The present embodiment is characterized by the procedure of the following processing performed by the processor 36-Cc provided in the terminal 16-Cc.

In the terminal 16-Cc, as in the above-described fourth embodiment, at the time of origination, a dial number indicating a desired terminating party (hereinafter, referred to as a main dial number) and a dial number indicating another terminating party that can be in place of the terminating party (hereinafter, referred to as a sub dial number) are specified via the operation display section 34-Cc.

The processor 36-Cc delivers only the above-described main dial number to the ADSL modem 13-C via the Bluetooth transmission path. Here, it is assumed that delivery of such the dial number is attained based on the above-described profile.

On the other hand, in the ADSL modem 13-C, the network processor 25-C starts processing that enables termination to the main terminating party indicated by the main dial number (here, it is assumed to be a terminal accommodated in the VoIP network for simplification of explanation) by applying only the above-described main dial number in the process of call setup of an originating call that occurs from the terminal 16-Cc.

However, in the process of such processing, if termination to the main terminating party is blocked by the busy state, congestion, obstruction, or other factors, and there is no response from the terminal of the main terminating party (including a case where the subscriber does not respond for a predetermined long period of time although ringing signals are being sent out), the network processor 25-C sends a notice to the effect (FIG. 4(8), FIG. 5(15)) and aborts processing relating to the termination to the main terminating party.

In the terminal 16-Cc, when identifying this notice (FIG. 4(9), FIG. 6(4)), the processor 36-Cc newly performs origination to the sub terminating party indicated by the sub dial number as follows by applying the sub dial number instead of the above-described main dial number (FIG. 4(10), FIG. 6(5)).
For example, when the sub dial number indicates a terminal accommodated in the mobile communication network such as “09012345678”, performing origination directly to the mobile communication network
For example, when the sub dial number indicates a terminal accommodated in the VoIP network such as “05012345678”, performing re-origination via the Bluetooth transmission path and interconnecting with the ADSL modem 13-C adequately

In other words, re-origination to the sub terminating party indicated by the sub dial number is realized under the initiative of the terminal 16-Cc, which is the originating party, not under the initiative of the ADSL modem 13-C as in the above-described fourth embodiment.

Therefore, according to the present embodiment, irrespective of the number of terminals accommodated in the ADSL modem 13-C via the Bluetooth transmission path, the loads are unlikely to concentrate in the ADSL modem 13-C wastefully and the call completion ratio of originating calls that occur from the terminals is improved and at the same time, the quality of services provided to the terminals can be improved at a low cost without hardware configuration of the ADSL modem 13-C being modified fundamentally.

### SIXTH EMBODIMENT

The operation of a six embodiment of the present invention is explained below with reference to FIG. 1 to FIG. 6.

The present embodiment is characterized by the procedure of the following processing performed by the processor 36-Cc provided in the terminal 16-Cc in cooperation with the network processor 25-C provided in the ADSL modem 13-C.

In the terminal 16-Cc, when detecting a state (hereinafter, referred to as a first state) in which the Bluetooth transmission path can be formed physically between the ADSL modem 13-C and itself based on the standard (for example, possible or not of establishment of synchronization) conforming to the transmission scheme applied to the Bluetooth transmission path, the Bluetooth interface section 32-Cc notifies this state to the processor 36-Cc.

When identifying such the first state (FIG. 6(a)), the processor 36-Cc notifies the ADSL modem 13-C of the unique number (here, assumed to be “05087654321”) conforming to the numbering plan of the VoIP network and assigned in advance to the local station via the Bluetooth transmission path (FIG. 4(b), FIG. 6(b)).

In the ADSL modem 13-C, network processor 25-C stores accommodation information indicating the accommodation of the terminal indicated by the number is completed in a specific storage region in the main storage along with the unique number (FIG. 4(c), FIG. 5(a)) and notifies the SIP server 21 of the number via the ADSL 11-C (FIG. 4(d), FIG. 5(b)).

The SIP server 21 registers the number thus notified (FIG. 4(e)) and in the process of call setup of a call that has occurred from the terminal 16-Cc, converts between the number assigned to the terminal 16-Cc and the IP address by adequately interconnecting with a location server (not shown).

Further, in the ADSL modem 13-C, when detecting a state (hereinafter, referred to as a second state) in which maintenance of the Bluetooth transmission path formed between the terminal 16-Cc and itself is impossible based on the above-described criteria, the Bluetooth interface section 21-C notifies the network processor 25-C of this state.

When identifying such the notice (FIG. 4(A), FIG. 5(A)), the network processor 25-C deletes the accommodation information associated with the relevant terminal 16-Cc and stored in the above-described specific storage region (FIG. 5(b)) and notifies the SIP server 21 of the number included in the accommodation information (FIG. 4(B), FIG. 5(C)).

Thus, the SIP server 21 releases the registration of the notified number (FIG. 4(C)).

In other words, the accommodation and its release of the terminal 16-Cc for the ADSL modem 13-C are attained automatically without the need for an operator of the terminal 16-Cc to perform a specific operation.

Therefore, according to the present embodiment, various functions provided to the ADSL modem 13-C can be utilized efficiently and securely and the availability of the terminal 16-Cc can be improved.

### SEVENTH EMBODIMENT

The operation of a seventh embodiment of the present invention is explained below with reference to FIG. 1 to FIG. 6.

The present embodiment is characterized by the procedure of the following processing performed by the processor 36-Cc provided in the terminal 16-Cc and the network processor 25-C provided in the ADSL modem 13-C.

In the terminal 16-Cc, when detecting the first state, the Bluetooth interface section 32-Cc notifies the processor 36-Cc of this state, as in the above-described sixth embodiment.

When identifying the first state (FIG. 4(a), FIG. 6(a)), the processor 36-Cc notifies the ADSL modem 13-C via the Bluetooth transmission path of both or either of the profile of the local station (including, for example, the telephone number of the operator's home) and the contents of the address book, along with the unique number conforming to the numbering plan of the VoIP network and assigned in advance to the local station (FIG. 4(b), FIG. 6(b)).

In the ADSL modem 13-C, the network processor 25-C stores the accommodation information indicating that the accommodation of the terminal indicated by the number is completed, the above profile, or the contents of the address book in the storage region in the main memory, along with the number (FIG. 4(C) FIG. 4(C)), and notifies the SIP server 21 via the ADSL 11-C of the number (FIG. 4(d) FIG. 5(b)).

The processing performed by the SIP server 21 in accordance with the number thus notified is the same as that of the above-described sixth embodiment, therefore, omitted here.

Further, in the ADSL modem 13-C, when detecting the second state in which maintenance of the Bluetooth transmission path formed between the terminal 16-Cc and itself is impossible based on the above-described criteria, the Bluetooth interface section 21-C notifies the network processor 25-C of this state.

When identifying such the notice (FIG. 4(A), FIG. 5(A)), as in the above-described sixth embodiment, the network processor 25-C deletes the relevant accommodation information (FIG. 5(B)) and continues to retain the above-described profile and the contents of address book in the specific storage region in the main storage instead of deleting them.

When a call that should arrive at the terminal 16-Cc occurs as an incoming call via the ADSL 11-C, the network processor 25-C performs call setup in order to adapt the incoming call to the above-described profile and complete it.

In the process of the call setup, when it is decided that the incoming call is not completed by any of the following factors (FIG. 4(11), FIG. 5(16)), the network processor 25-C performs the following processing (1) and (2).
The accommodation information of the terminal 16-Cc corresponding to the terminating party is not stored in the specific storage region of the main storage.
Congestion of the Bluetooth transmission path
The terminal 16-Cc does not respond normally in the process of call setup, or an operator of the terminal 16-Cc does not respond to the calling for a predetermined long period of time.
(1) Referring to the profile or address book stored in the storage region in the main storage associated with the terminal 16-Cc and identifying the number (hereinafter, referred to as the alternative number) of the terminal (here, assumed to be another terminal accommodated in the ADSL modem 13-C via the Bluetooth transmission path) that can be permitted to be a terminating party in place of the terminal 16-Cc (FIG. 4(12), FIG. 5(17)).
(2) Changing the terminating party to the terminal indicated by the alternative number (FIG. 4(13), FIG. 5(18)) and continuing call setup of the relevant arriving call based on the procedure adapted to the above-described profile.

In other words, since the above-described profile or address is referred to effectively, the call setup of the terminating call that has occurred as an incoming call from the VoIP network completes the call with a high probability.

Therefore, according to the present embodiment, the transmission capacity of the Bluetooth transmission path is utilized effectively and the quality of services provided to the respective terminals that are or which should be accommodated via the Bluetooth transmission path is improved.

In the embodiment of the present invention, only the number of the terminal accommodated in the ADSL modem 13-C via the Bluetooth transmission path is applied as the alternative number.

However, the alternative number like this is not limited to the terminal like this and for example, may be the number of any of the following terminals, and the procedure of call setup in accordance with the number is the same as the procedure of the processing performed by applying the relevant alternative number as the sub dial number in the above-described fourth embodiment.
Terminals accommodated in the VoIP network
Terminals accommodated in the mobile communication network
Any of the telephones 15-1 to 15-n

Further, in the present embodiment, when termination to the terminal 16-Cc is not attained, a terminating call to another terminating party that can be a terminating party in place of the terminal 16-Cc is transferred.

However, the present invention is not limited to this case and can be applied similarly even in the case where, for example, an originating call that has occurred from the terminal 16-Cc is prevented from arriving at a desired terminating party or from being completed, as long as the above-described alternative number is given without fail.

### EIGHTH EMBODIMENT

The operation of an eighth embodiment of the present invention is explained below with reference to FIG. 1 to FIG. 3.

The present embodiment is characterized by the procedure of the following processing performed by the network processor 25-C provided in the ADSL modem 13-C.

In the ADSL modem 13-C, when a call that should arrive at the terminal 16-Cc occurs as an incoming call via the ADSL 11-C, the network processor 25-C performs the following processing.
Referring to the service order (included, for example, in the accommodation information of the terminal 16-Cc) of the terminal 16-Cc andjudging whether or not that termination to the terminal 16-Cc should be the object of global termination to be described later is meant.
When the result of the judgment is false, continuing call setup (here, assumed to be performed based on the procedure adapted to the profile and its detailed explanation is omitted) that enables termination only to the terminal 16-Cc.
However, when the result of the judgment is true, identifying all of the terminals belonging to the termination group common to the above-described terminal 16-Cc among the terminals and the telephones 15-C accommodated under the command thereof via the Bluetooth transmission path and activating call setup that enables the global termination to all of the terminals.

Therefore, in the present embodiment, since the surplus transmission capacity of the Bluetooth transmission path is utilized effectively, the call completion ratio of incoming calls the terminating party of which corresponds to the terminal 16-Cc is increased and the quality of services provided to a subscriber of the terminal 16-Cc is improved.

In the present embodiment, only the terminals and the telephone 15-C accommodated under the command thereof via the Bluetooth transmission path belong to the termination group common to the above-described terminal 16-Cc.

However, to the terminal belonging to the common termination group like this, for example, either of the terminal accommodated via the VoIP network and the terminal accommodated in the mobile communication network may correspond.

Further, in the present embodiment, as for the terminal accommodated under the command thereof via the Bluetooth transmission path, the above-described service order and the termination group are delivered from the terminal as part of the accommodation information and referred to adequately.

However, these service order or termination group may be given to, for example, the network processor 25-C by the personal computer 14-C or may be given to the network processor 25-C as station information included as part of software.

### NINTH EMBODIMENT

The operation of a ninth embodiment of the present invention is explained below with reference to FIG. 1 to FIG. 6.

As shown in FIG. 2 by the dotted line, hardware in the present embodiment is configured as follows.
The ADSL interface section 22-C provided in the ADSL modem 13-C has an analog modem terminal and is connected to a modulation/demodulation terminal of the modem 26-C arranged on the outside via the analog modem terminal.
The ADSL 11-C is connected to a subscriber line 28-C via a splitter 27-C along with the line terminal of the above-described modem 26-C.

The present embodiment is characterized by the procedure of the following processing performed by the network processor 25-C provided in the ADSL modem 13-C and the processor 36-Cc provided in the terminal 16-Cc.

In the terminal 16-Cc, when the terminal 16-Cc uses an IP telephone or accesses the Internet 12, authentication information (here, assumed to be a pair of password and predetermined identification information) is inputted by an operator via the operation display section 34-Cc (FIG. 4(P)).

When acquiring such authentication information (FIG. 6(P)), the processor 36-Cc delivers the authentication information to the ADSL modem 13-C via the Bluetooth transmission path (FIG. 4(Q), FIG. 6(Q)).

On the other hand, in the ADSL modem 13-C, the network processor 25-C performs the following processing.
Judging whether or not the above-mentioned authentication information conforms to the predetermined information (for example, given by an authentication server etc. arranged on the Internet 12 via the ADSL 11-C) stored in advance in the main storage (FIG. 4(R), FIG. 4(P).
When the result of the judgment is false, promoting a notice to the effect that authentication information should be set again for the operator of the terminal 16-Cc by delivering a message to that effect to the terminal 16-Cc via the Bluetooth transmission path (FIG. 4(S), FIG. 5(Q)).
When the result of the judgment is true, promoting a notice that authentication is completed and access to the Internet 12 is permitted to the operator of the terminal 16-Cc by delivering a message to that effect to the above-mentioned terminal 16-Cc (FIG. 4(T), FIG. 5(R)).

Further, the network processor 25-C realizes the access to the Internet 12 by the terminal 16-Cc for which the above-described authentication has been completed (including access performed in the process of call setup of an originating call that has occurred from the terminal 16-Cc or a terminating call that has occurred as an incoming call from the Internet 12 and which should arrive at the terminal 16-Cc) via the splitter 27-C and the subscriber line 28-C by interconnecting with the modem 26-C via the ADSL interface section 22-C, not the ADSL 11-C.

As described above, according to the present embodiment, access to the Internet 12 is permitted only for the terminal 16-Cc for which the above-mentioned authentication has been completed even in the case where the access is performed via the modem 26-C connected to the subscriber line 28-C of dial-up scheme via the splitter 27-C, not via the ADSL 11-C to be used for continuous connection.

Therefore, according to the present embodiment, access to the Internet 12 via a terminal that is accommodated via the Bluetooth transmission path and use of an IP telephone are made possible even in the circumstances in which the ADSL 11-C etc. that enables continuous connection is not installed.

In the present embodiment, the modem 26-C and the splitter 27-C are provided separately from the ADSL interface section 22-C.

However, the present invention is not limited to such the configuration and the modem 26-C and the splitter 27-C may be incorporated to, for example, both or either of the ADSL interface section 22-C and the telephone interface section 23-C in any of forms.

Further, in each of the above-described embodiments, the IP telephone service is provided under the application of SIP to the terminal accommodated in the ADSL modem 13-C via the Bluetooth transmission path.

However, the present invention can be applied similarly to the case, for example, where the IP telephone service is realized based on H.323 or other communication protocols in place of SIP.

Further, in each of the above-described embodiments, for example, the broadband CDMA scheme is applied to the mobile communication network that can be accessed directly by the terminal 16-Cc.

However, any of the zone configuration, channel configuration, multiple access scheme, and modulation/demodulation scheme may be applied to the mobile communication network like this and the mobile communication network may differ for each terminal accommodated in the common ADSL modem via the Bluetooth transmission path.
Further, in each of the above-described embodiments, in the ADSL modem 13-C, the terminal 16-Cc is accommodated via the Bluetooth transmission path.

However, not limited to the installation to the terminal 16-Cc, the Bluetooth transmission path may be replaced with any of radio transmission systems as long as it is realized without being impeded by limitations relating to power consumption and other costs and both the interface corresponding to the predetermined profile and the interface with the entity in the communication layer that realizes the SIP etc. are provided.

Further, in each of the above-described embodiments, in the ADSL modem 13-C capable of accommodating a plurality of terminals via the Bluetooth transmission path, upper layers equal to or higher than the session layer relating to the SIP are terminated and firmware that realizes a communication control based on the SIP is stored in advance in the ADSL modem 13-C.

However, such firmware may be caused to flexibly adapt to changes of the procedure of the above-mentioned communication control and other specifications by, for example, downloading it adequately from a predetermined site on the Internet 12 via the ADSL 11-C.

Further, in each of the above-described embodiments, the present invention is applied to the ADSL modem 13-C connected to the ADSL 11-C.

However, the present invention is not limited to such an ADSL and can also be applied to a DSL modem to which a metallic access system has been applied and which terminates a digital subscriber line, and may also be applied to various modems that realize the continuous connection service with the Internet, such as a cable modem.

Further, in each of the above-described embodiments, any one of the processing performed as that characterizing the present invention is described with only the single terminal 16C being focused.

However, such processing may be realized as multiplexed processing in any form as long as each section is not put into an overloaded state and processing is performed in parallel in the range of the transmission capacity of the Bluetooth transmission path.

The present invention is not limited to the above-described embodiments and various embodiments can be made in the scope of the present invention and part or all of the component devices may be improved in any manner.

### INDUSTRIAL APPLICABILITY

As described above, with the first broadband transmission path modem according to the present invention, the surplus transmission capacity of the radio access link and the surplus throughput of the terminal and the broadband transmission path modem according to the present invention are utilized effectively and the added value is increased.

With the second broadband transmission path modem according to the present invention, without being limited by the specification of the radio access link, the surplus transmission capacity of the radio access link is utilized effectively and the added value is increased.

With the third broadband transmission path modem according to the present invention and the first radio terminal device, various communication services are provided.

With the fourth to sixth broadband transmission path modems according to the present invention, the store-and-forward switching network or the message switching network connected via the broadband transmission path are not interposed and the availability of the terminal accommodated via the radio access link is improved.

With the seventh broadband transmission path modem according to the present invention, the availability of the terminal accommodated via the radio access link is improved.

With the eighth broadband transmission path modem according to the present invention and the second radio terminal device according to the present invention, accommodation, removal, and relocation of the terminal is attained simply and reliably.

With the ninth to tenth broadband transmission path modems according to the present invention and the third to fifth radio terminal devices, the quality of service is improved, in addition to the call completion ratio of terminating calls.

With the twelfth broadband transmission path modem according to the present invention, even in an environment in which continuous connection via the broadband transmission path is not available, the terminal accommodated via the radio access link is provided with a service that enables access to the above-described store-and-forward switching network or the message switching network, and the telephone service via these networks.

With the thirteenth broadband transmission path modem according to the present invention, the surplus transmission capacity of the radio access link is utilized effectively and the availability of the terminal accommodated via the radio access link is improved.

With the sixth radio terminal device according to the present invention, it is possible to receive a communication service via a network conforming to the intension of an operator, the location of the radio terminal device, and other environments.

With the seventh radio terminal device according to the present invention, without being limited by the specification of the radio access link, the surplus transmission capacity of the radio access link is utilized effectively and the added value is increased.

Therefore, in a communication system to which the present invention is applied, it is made possible to provide various communication services along with flexible adaptation to the forms and environments in which the terminal capable of accessing a mobile communication system is used without a considerable increase in cost or complex work relating to maintenance and management.

1. A broadband transmission path modem comprising:
a first interfacing section that terminates a broadband transmission path through which speech signals are transmitted as a sequence of packets in compliance with a predetermined communication protocol;
a second interfacing section that forms a radio access link used for accommodation of a terminal accessible to said broadband transmission path; and
a controller that interfaces functions of an entity realizing said communication protocol and an entity realizing said radio access link and converts transmission information to be delivered to realize an added function, the functions being defined in advance as a specification of the radio access link, the added function being a function not defined in the specification.

2. The broadband transmission path modem according to claim 1, wherein
said controller assigns a single channel on said radio access link to a call occurring first in each terminal accessible to said broadband transmission path, and multiplex-transmits information about setup of the first call and of a call occurring subsequent to the first call by using the single channel.

3. The broadband transmission path modem according to claim 1, wherein
said added function is a function to hold a communication channel which is assigned to a completed call and formed in said broadband transmission path or both of said broad band transmission path and said radio access link, the completed call being specified by a terminal from a plurality of completed calls that occur and persist in the terminal accommodated via said radio access link.

4. The broadband transmission path modem according to claim 1, wherein said added function is a function to deliver transmission information between a communication channel assigned to a single completed call specified by a terminal and a single channel assigned to the terminal on the radio access link, the communication channel being one of communication channels which are formed in said broadband transmission path and individually assigned to a plurality of completed calls that occur and persist in the terminal accommodated via said radio access link.

5. The broadband transmission path modem according to claim 1, wherein
said added function is a function to perform a number translation of an originating call that occurs in a terminal accommodated via said radio access link or a line transmission path, and to cause, according to a result of the number translation, the originating call to arrive at another terminal accommodated via the radio access link or the line transmission path.

6. The broadband transmission path modem according to claim 1, wherein
said added function is a function to cause, when it is identified that an originating call occurring in a terminal is to be an incomplete call, the originating call to arrive at a terminating party indicated by an alternative number given by the terminal, the terminal being accommodated via said radio access link or a line transmission path and to be routed via said broadband transmission path as an outgoing route.

7. The broadband transmission path modem according to claim 1, wherein
said added function is a function to set up calls which occur and persist in individual terminals accommodated via said radio access link and with which making a call is possible via said broadband transmission path as well as to assign a communication channel to the calls via one or both of said radio access link and said broadband transmission path.

8. The broadband transmission path modem according to claim 1, wherein
said added function is a function to convert, when a terminal accommodated via said radio access link notifies a number, between the number and an IP address of the terminal in a process of call setup for the terminal, or notifies the number and the IP address to a server involving with the conversion.

9. The broadband transmission path modem according to claim 1, wherein
said added function is a function to judge whether or not a terminating call is able to arrive at a terminal accommodated via said radio access link or a line transmission path, and to transfer the terminating call to another terminal accommodated via the radio access link or the line transmission path when a result of the judgment is negative.

10. The broadband transmission path modem according to claim 1, wherein
said added function is a function to judge whether or not an originating call from a terminal accommodated via said radio access link or a line transmission path is able to arrive at a terminating party, and to transfer the originating call to another terminating party specified by the terminal when a result of the judgment is negative.

11. The broadband transmission path modem according to claim 1, wherein
said added function is a function to page, when an incoming call occurs via said broadband transmission path and is to arrive at any of terminals accommodated via said radio access link or a line transmission path, a plurality of terminals accommodated via the radio access link and the line transmission path as candidates for a terminating party of the incoming call.

12. The broadband transmission path modem according to claim 1, further comprising
a third interfacing section that interfaces an access point with a subscriber line accessible via a circuit switched network, the access point connected to a store-and-forward switching network or a message switching network being accessible via said broadband transmission path, wherein
said added function is a function to authenticate a terminal accommodated via said radio access link, and to access, upon completion of the authentication, said store-and-forward switching network or message switching network based on said predetermined communication protocol via said broadband transmission path and said access point.

13. The broadband transmission path modem according to claim 1, wherein
said added function is a function to multicast, to all of communication channels of a plurality of completed calls that occur and persist in terminals accommodated via said radio access link, transmission information delivered via the other communication channels.

14. A radio terminal device comprising:
a first interfacing section that interfaces with a mobile communication network;
a second interfacing section that interfaces with a radio access link other than said mobile communication network; and
a controller that sets up one call which occurs in a local station and whose communication channel is formed via said radio access link, and sets up another call whose communication channel is formed via said mobile communication network or said radio access link, and maintains, when both of the calls persist as completed calls, a speech relating to one of the completed calls specified by an operator and holds the communication channel of the other completed call.

15. A radio terminal device comprising:
a first interfacing section which interfaces with a mobile communication network;
a second interfacing section used for accessing a radio access link other than said mobile communication network, when detecting a state that the access is possible; and
a controller that sets up one call which occurs in a local station and whose communication channel is formed via said radio access link, and sets up another call whose communication channel is formed via said mobile communication network or said radio access link, wherein
when detecting the state, said second interfacing section delivers, to said radio access link, a number assigned in advance to a local station and conforming to a numbering plan of a network accessible via said radio access link.

16. A radio terminal device comprising:
a first interfacing section that interfaces with a mobile communication network;
a second interfacing section used for accessing a radio access link other than said mobile communication network, when detecting a state that the access is possible;
a profile storage section in which a number given to a terminal is registered, the terminal is to be a transfer destination of a terminating call that is to arrive at a local station; and
a controller that sets up one call which occurs in a local station and whose communication channel is formed via said radio access link, and sets up another call whose communication channel is formed via said mobile communication network or said radio access link, wherein
when detecting the state, said second interfacing section delivers the number registered in said profile storage section to said radio access link.

17. A radio terminal device comprising:
a first interfacing section that interfaces with a mobile communication network;
a second interfacing section used for accessing a radio access link other than said mobile communication network, when detecting a state that the access is possible;
a number storage section in which a plurality of numbers given to individual opposite parties are registered, the opposite parties being to be terminating parties of an originating call from a local station; and
a controller that sets up one call which occurs in a local station and whose communication channel is formed via said radio access link, and sets up another call whose communication channel is formed via said mobile communication network or said radio access link, wherein
when detecting the state, said second interfacing section delivers all of the numbers registered in said number storage section to said radio access link.

18. A radio terminal device comprising:
a first interfacing section that interfaces with a mobile communication network;
a second interfacing section used for accessing a radio access link other than said mobile communication network, when detecting a state that the access is possible;
a number storage section in which a plurality of numbers given to individual opposite parties are registered, the opposite parties being to be terminating parties of an originating call from a local station; and
a controller that sets up one call which occurs in a local station and whose communication channel is formed via said radio access link, and sets up another call whose communication channel is formed via said mobile communication network or said radio access link, and that re-originates, when it is determined that one of the calls as an originating call is incomplete, a call by using a number registered in said number storage section and given to an opposite party as a terminating party of the originating call.

19. The radio terminal device according to claim 14, wherein
when an originating call occurs in the local station, said controller causes the originating call to arrive at a terminating party via one of said mobile communication network and said radio access link which conforms to all or part of a result of a number translation of the terminating party of the originating call, an instruction from an operator, and a predetermined program.

20. The radio terminal device according to claim 15, wherein
when an originating call occurs in the local station, said controller causes the originating call to arrive at a terminating party via one of said mobile communication network and said radio access link which conforms to all or part of a result of a number translation of the terminating party of the originating call, an instruction from an operator, and a predetermined program.

21. The radio terminal device according to claim 16, wherein
when an originating call occurs in the local station, said controller causes the originating call to arrive at a terminating party via one of said mobile communication network and said radio access link which conforms to all or part of a result of a number translation of the terminating party of the originating call, an instruction from an operator, and a predetermined program.

22. The radio terminal device according to claim 17, wherein
when an originating call occurs in the local station, said controller causes the originating call to arrive at a terminating party via one of said mobile communication network and said radio access link which conforms to all or part of a result of a number translation of the terminating party of the originating call, an instruction from an operator, and a predetermined program.

23. The radio terminal device according to claim 18, wherein
when an originating call occurs in the local station, said controller causes the originating call to arrive at a terminating party via one of said mobile communication network and said radio access link which conforms to all or part of a result of a number translation of the terminating party of the originating call, an instruction from an operator, and a predetermined program.

24. The radio terminal device according to claim 14, wherein
for delivering information about setup of a call that occurs first in the local station and of a call that occurs subsequent to the first call, said controller multiplex-transmits the information by using a single channel assigned to the first call and formed on said radio access link.

25. The radio terminal device according to claim 15, wherein
for delivering information about setup of a call that occurs first in the local station and of a call that occurs subsequent to the first call, said controller multiplex-transmits the information by using a single channel assigned to the first call and formed on said radio access link.

26. The radio terminal device according to claim 16, wherein
for delivering information about setup of a call that occurs first in the local station and of a call that occurs subsequent to the first call, said controller multiplex-transmits the information by using a single channel assigned to the first call and formed on said radio access link.

27. The radio terminal device according to claim 17, wherein
for delivering information about setup of a call that occurs first in the local station and of a call that occurs subsequent to the first call, said controller multiplex-transmits the information by using a single channel assigned to the first call and formed on said radio access link.

28. The radio terminal device according to claim 18, wherein
for delivering information about setup of a call that occurs first in the local station and of a call that occurs subsequent to the first call, said controller multiplex-transmits the information by using a single channel assigned to the first call and formed on said radio access link.

29. A program that causes a computer to function as a controller that constitutes the broadband transmission path modem according to claim 1.

30. A program that causes a computer to function as a controller that constitutes the radio terminal device according to claim 14.

31. A computer-readable storage medium that stores a program to cause a computer to function as a controller that constitutes the broadband transmission path modem according to claim 1.

32. A computer-readable storage medium that stores a program to cause a computer to function as a controller that constitutes the radio terminal device according to claim 14.
